(19) United States
(12) Patent Application Publication
(10) Pub. No.: US 2007/0067118 A1
(43) Pub. Date: Mar. 22, 2007

(54) Rechargeable food thermometer

(76) Inventor: Kerry John Cooper, Pleasantville, NY (US)

Correspondence Address: DUANE MORRIS LLP, PO BOX 5203, PRINCETON, NJ, 08543-5203, US

(21) Appl. No.: 11/229,865

(22) Filed: Sep. 19, 2005

(51) Int. Cl. G06F 19/00

(52) U.S. Cl. 702/57

(57) ABSTRACT

A rechargeable thermometer system is disclosed having a rechargeable thermometer and a charging assembly. The rechargeable thermometer is releasably engageable with the charging assembly, which in turn can be plugged into a household electrical outlet to provide charging electricity to a rechargeable battery housed within the thermometer. The thermometer is electrically connectable to the charging assembly to receive a charge so that when the thermometer is separated from the charger it can be used to sense the temperature of a food product into which the thermometer probe tip is introduced. The charging assembly has a pass-through plug to allow household appliances to be plugged into charger to receive electrical energy from the household outlet into which the charger itself is plugged. The thermometer can be held by the charger when not in use, thus ensuring the thermometer will always be fully charged prior to use.

### FIELD OF THE INVENTION

The invention relates to a rechargeable food thermometer, and more particularly to a rechargeable food thermometer system that can plug into a wall electrical outlet to provide constant recharging of the thermometer held therein.

### BACKGROUND OF THE INVENTION

A variety of food items today are prepared according to individual taste preferences. Meat, for example, may be cooked rare, medium rare, medium, medium well, or well done. Such different cooking choices are generally referred to as “doneness” or “taste”. Beef is one meat that is particularly well suited to different levels of doneness. This may not be true, however, for other kinds of meat, such as poultry or pork, which are typically cooked until “well done” as a safety factor. Various forms of meat thermometers are known that provide an indication of the level of doneness. Thus, in addition to providing assurance that a food item has not been overcooked, current thermometers also may be used to help to avoid undercooking, thereby minimizing the chance for bacteria related food borne illnesses.

Typically, a thermometer has a temperature sensing tip, or thermistor, that is inserted into the meat to measure its internal temperature. While it is known that certain temperature ranges correspond to certain levels of doneness for various kinds of meat, current food thermometers may only display an approximate temperature which the user must then correlate to the appropriate level of doneness. More sophisticated food thermometers may include electronic devices having enhanced features including selectable preset meat types, as well as one or more readouts to signal or otherwise indicate an instantly-measured level of doneness. Current electronic thermometer devices, however, suffer from a number of problems. They can be bulky (e.g. where the thermometer is incorporated into a utensil such as a cooking fork, where the thermometer probe is connected by wire to a base unit, or where increased size is required simply to accommodate large-sized batteries), requiring storage in already-overstuffed kitchen drawers. Additionally, if the thermometer is out of sight (e.g., in a drawer, cabinet, etc.), it may not be used as often as it should be. Further, current thermometers may be powered by AA or AAA or 3V batteries, which, even during short-term storage in the device, can go dead, thus leaving the user with a non-functioning device or forcing the user to search for new batteries at an inopportune time during the cooking process. Additionally, the problem of battery drain has effectively prevented the incorporation of a number of desirable features into a workable thermometer unit, where such features require additional electrical load for effective functioning. This is because current consumer expectations require a unit to function for nine months to a year prior to requiring a battery change.

Thus, there is a need for an electronic food temperature thermometer system which is compact, light, conveniently accessible, and which is always fully powered, thus providing substantially increased convenience to the user compared to present devices.

### SUMMARY OF THE INVENTION

A rechargeable food monitoring system is disclosed, comprising a thermometer having a probe portion, a display portion, and a rechargeable battery electrically connected to a charge receiving surface. The battery may be configured to provide operating power to the thermometer. The system may further comprise a charging assembly having a recess for engaging the thermometer, a plug for engaging an electrical outlet, and a charging surface configured to contact said charge receiving surface of said thermometer when said thermometer is engaged with said charging assembly. Thus, when the thermometer is engaged with the charging assembly such that the charging surface is electrically connected to the plug, electricity may be conducted from the electrical outlet to the battery via contact between the charging surface and the charge receiving surface.

A rechargeable food monitoring system is also disclosed, comprising a rechargeable thermometer having a probe portion, a display portion, a rechargeable battery, and an electrical charge receiving surface. The system may further have a charging portion releasably connectable with said recharging thermometer. The charging portion may further comprise a plug assembly for engaging an electrical outlet for receiving electrical current therefrom. The charging portion may also comprise an electrical charging surface, wherein when the rechargeable thermometer is received by the charging portion, the electrical charge receiving surface may contact the electrical charging surface to conduct electricity from the electrical outlet to the rechargeable battery.

A rechargeable food monitoring system is further disclosed, comprising a rechargeable thermometer having a probe portion, a display portion having a top surface comprising a display region, an electrically conductive surface, and a rechargeable battery electrically connected to the electrically conductive surface. The system may further comprise a charging assembly having a receiving surface for receiving at least a portion of said rechargeable thermometer, and a plug portion for engaging an electrical outlet to receive electrical current therefrom. The charging assembly may further comprise a charging surface for contacting the electrically conductive surface of the rechargeable thermometer when the rechargeable thermometer is received by the receiving surface to transfer an electrical current from the electrical outlet to the rechargeable battery. Thus, the charging unit may have a first detent element for engaging the rechargeable thermometer for retaining the rechargeable thermometer to the charging assembly. Additionally, the charging unit further may comprise an electrical socket element for receiving a plug of an electrical device, the electrical socket element allowing the electrical device to receive electrical current from the electrical outlet.

### BRIEF DESCRIPTION OF THE DRAWINGS

Other objects, advantages and novel features of the invention will become more apparent from the following detailed description of the invention when considered in conjunction with the accompanying drawings, wherein:

FIG. 1 is a perspective view of the rechargeable food thermometer and charging holder of the present invention;

FIG. 2 is a bottom cross section view of the rechargeable food thermometer and charging holder of FIG. 1, taken along line 2-2;

FIG. 3 is a plan view of the face of the rechargeable food thermometer of FIG. 1;

FIG. 4a is a perspective view of the rechargeable food thermometer and charging holder of FIG. 1, showing the thermometer detached from the charging holder;

FIG. 4b is a perspective view of the rechargeable food thermometer and charging holder of FIG. 4a, showing the optional probe sheath;

FIG. 5 is an exploded view of the rechargeable food thermometer and charging holder of FIG. 1;

FIGS. 6a and 6b are side and front elevation views, respectively, of a first alternative embodiment of the rechargeable food thermometer and charging holder of the present invention;

FIG. 7 is a perspective view of a second alternative embodiment of the rechargeable food thermometer and charging holder of the present invention;

FIGS. 8a, 8b are front and side views of the charging holder of FIG. 7;

FIG. 8c is a bottom plan view of the rechargeable food thermometer of FIG. 7.

### DETAILED DESCRIPTION

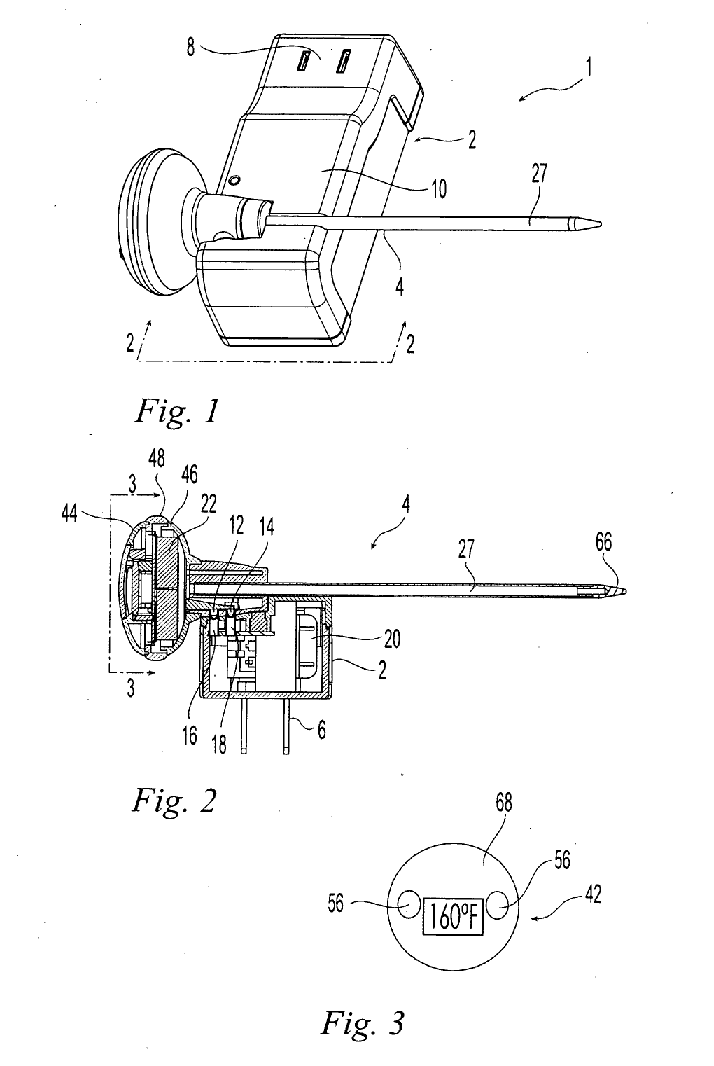

Referring to FIG. 1, a rechargeable food safety thermometer system 1 is shown comprising a charging portion 2 and a rechargeable thermometer 4. The charging portion 2 and thermometer 4 may be releasably engageable to allow the thermometer to be conveniently stored on the charging portion 2 when not in use, and also to allow the thermometer 4 to receive an electrical charge from the charging portion 2 and to store-that charge in a battery within the rechargeable thermometer 4, thus ensuring that the thermometer is always appropriately powered prior to use. Thus, the charging portion 2 may have a plug 6 for plugging into a household or other electrical outlet to receive electrical power from a home or commercial electrical system and to transfer that power to the thermometer.

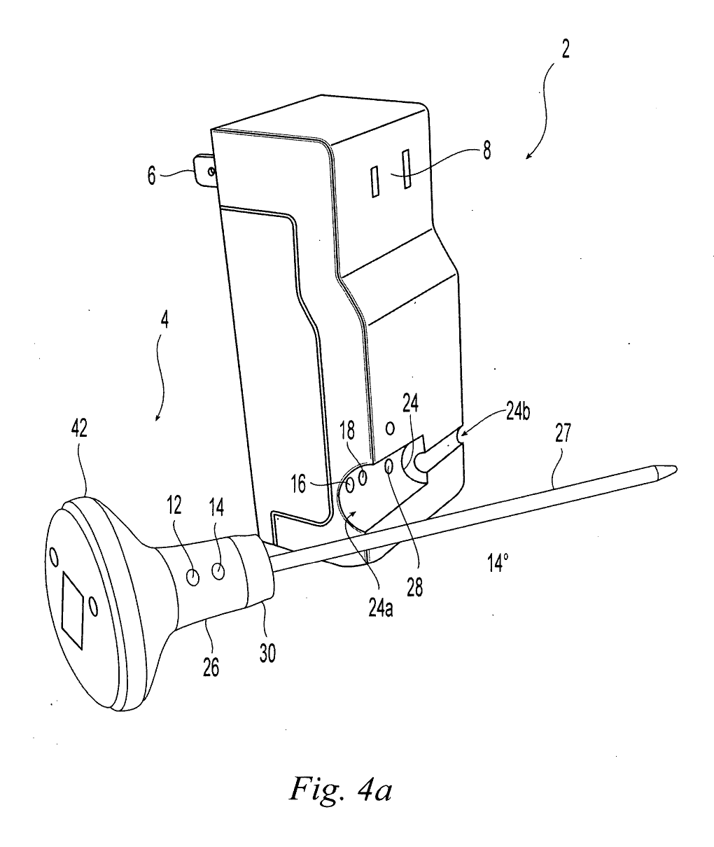

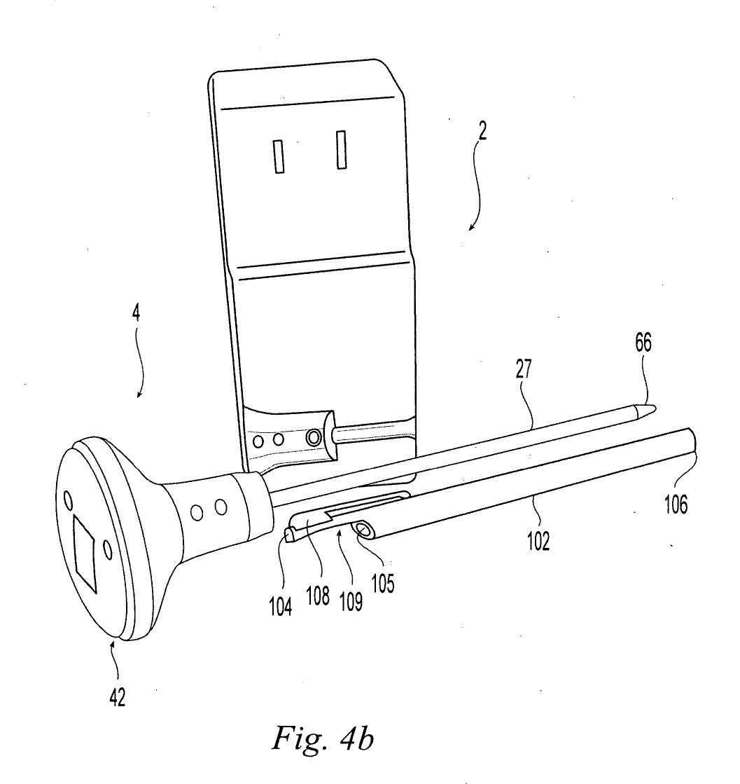

In use, the system 1 may be plugged into a household electrical outlet adjacent a kitchen stove or other food preparation surface, thus positioning the thermometer 4 in an always-convenient access location. To use the thermometer 4, a slight hand pressure can be applied to the thermometer 4 to disengage it from the charging portion 2 (see FIG. 4a). Since it is a separate piece, the thermometer 4 can then be moved to a desired location (indoor/outdoor) to measure the temperature of a targeted food product. After use, the thermometer 4 may again be engaged with the charging portion 2 for storage and continued charging.

To provide maximum convenience, it is expected that the system 1 will remain plugged into the household electrical outlet on a relatively constant basis, thus ensuring that the thermometer 4 is always appropriately charged. To minimize any impact the system 1 might have on the use of other household electrical appliances, the charging portion 2 may be provided with a “pass-through” plug 8, accessible via a front surface 10 of the charging portion 2 to enable a household appliance or the like to be “plugged into” the charging portion 2 to thereby receive electrical power from the electrical outlet when the charging portion 2 is plugged in.

Referring to FIG. 2, the thermometer 4 is shown engaged with the charging portion 2. Electrical contacts 12, 14 are provided on the thermometer 4 and are positioned to engage corresponding contacts 16, 18 on the charging portion 2 for transferring the electrical charge when the thermometer 4 is engaged with the charging portion 2. The charging portion contacts 16, 18 are, in turn, electrically connected to the plug 6 for receiving electrical current from the household outlet. An electrical adapter or transformer 20 may be provided within the charging portion 2 to convert the typical 120 Volt AC current to a low-voltage DC current suitable for charging the battery 22 in the thermometer 4.

As shown in FIG. 4a, the charging portion 2 may have a horizontally-oriented recess 24 configured to releasably engage a correspondingly-shaped neck portion 26 of the thermometer 4 to lock the two together. In the illustrated embodiment, the recess 24 comprises a first portion 24a configured to engage the neck portion 26 of the thermometer 4 and a second portion 24b configured to receive a portion of the shaft 27 of the thermometer. As can be seen, electrical contacts 12, 14 of the thermometer are positioned on the neck portion 26 at appropriate intervals so as to align with the corresponding contacts 16, 18 of the charging portion 2 which are located within the recess 24. Thus, when the neck portion 26 of the thermometer 4 is received within the recess 24 of the charging portion 2, the electrical contacts are engaged with each other.

A detent mechanism may be provided to retain the thermometer 4 in place within the recess 24 of the charging portion 2, and to ensure that adequate electrical contact is maintained between the contacts 12, 14; 16, 18 when the thermometer 4 is not in use. In one embodiment, a small magnet 28 may be provided within the recess 24 of the charging portion 2. The neck portion 26 of the thermometer 4 may be provided with a thin metal ring 30 at a location corresponding to the magnet 28 so that when the thermometer neck portion 26 is received within the recess 24, the magnetic connection between magnet 28 and ring 30 is sufficient to retain the thermometer 4 and charging portion 2 together.

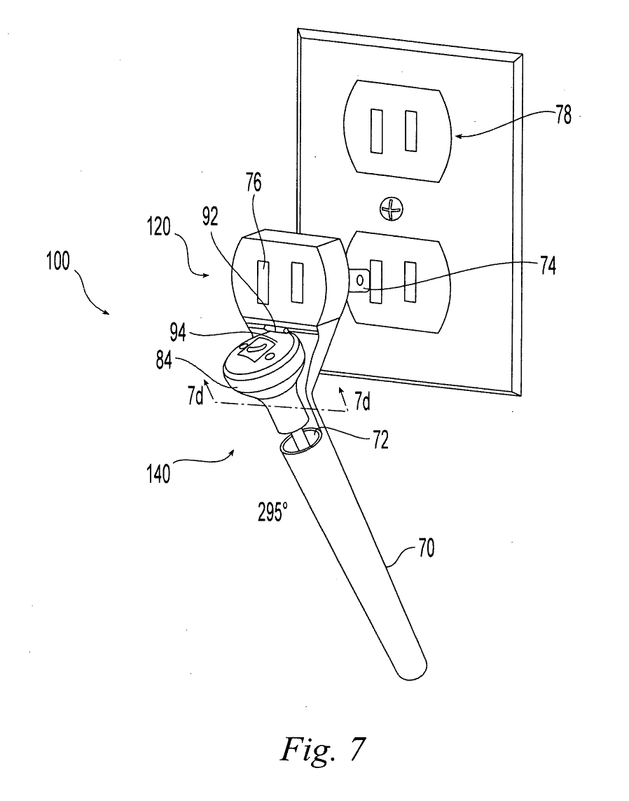

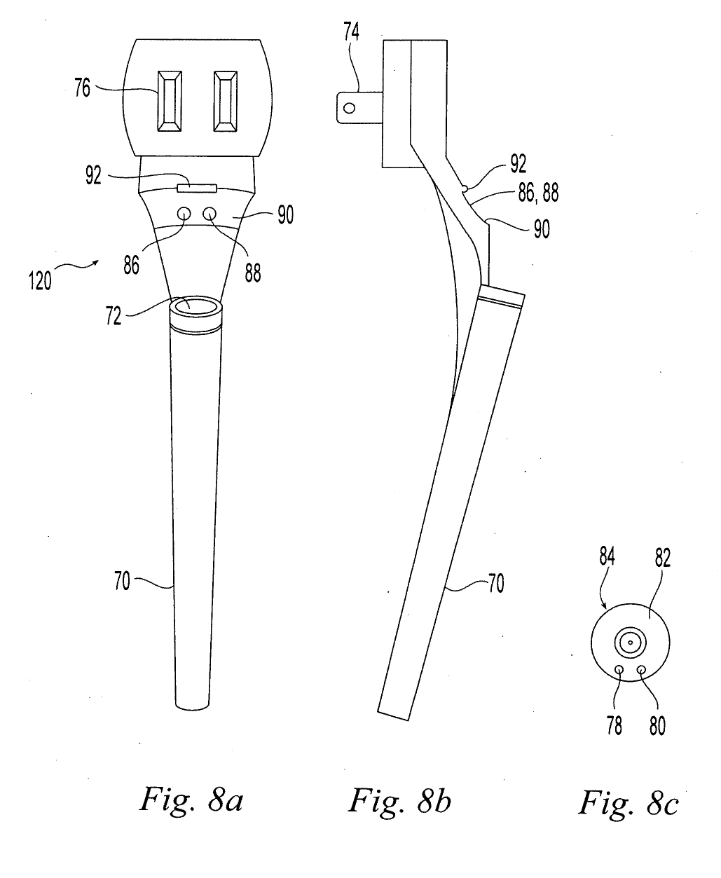

Although the illustrated embodiment uses a magnetic detent mechanism, it will be appreciated that other detents may also be used, such as snap-lock fittings (where a portion of the thermometer neck portion 26 snaps into a corresponding portion of the charging portion 2 (see FIGS. 7-8b). Additionally, it is noted that the orientation of the thermometer 4 with respect to the charging portion 2 is not critical, and that other arrangements are contemplated. For example, the thermometer 4 could be oriented vertically with respect to the charging portion 2, and/or a portion of the shaft 28 could be partially or fully received within a bore in the charging portion 2 (see FIGS. 7-8b).

FIG. 4b shows a sheath 102 for use with the system 1 to protect the user from potential injury resulting from contact with the thermometer tip 66 which may be sharp. The sheath 102 may also keep the thermometer shaft 27 of the thermometer 4 clean when not in use. The sheath 102 may be an elongated cylindrical member with a longitudinally oriented bore 104 sized and configured to receive a substantial portion of the shaft 27. The sheath 102 may have a proximal end 104 that is positioned adjacent the housing 42 of the thermometer 4, and a distal end 106 that is positioned beyond the thermometer tip 66 when the shaft 27 is fully inserted within the bore 105. A clip 108, similar to that used for fountain pens, may be provided at or near the proximal end 104 of the sheath 102 to allow the user to conveniently carry the thermometer 4 in a shirt pocket. In one exemplary embodiment, the sheath 102 may have a cutout or scallop 109 located opposite the clip 108 to enable the thermometer 4 to engage the charging portion 4 without interference from the sheath 102. Alternatively, the sheath 102 may be provided without a cutout/scallop 109, which may require that the recess 24b in charging portion 4 be provided with an increased diameter that is sized to accommodate the outer diameter of the sheath 102. As a further convenience, the sheath 102 may have a USDA cooking chart attached, stamped or otherwise printed or embossed thereon to allow for easy referral during use of the thermometer.

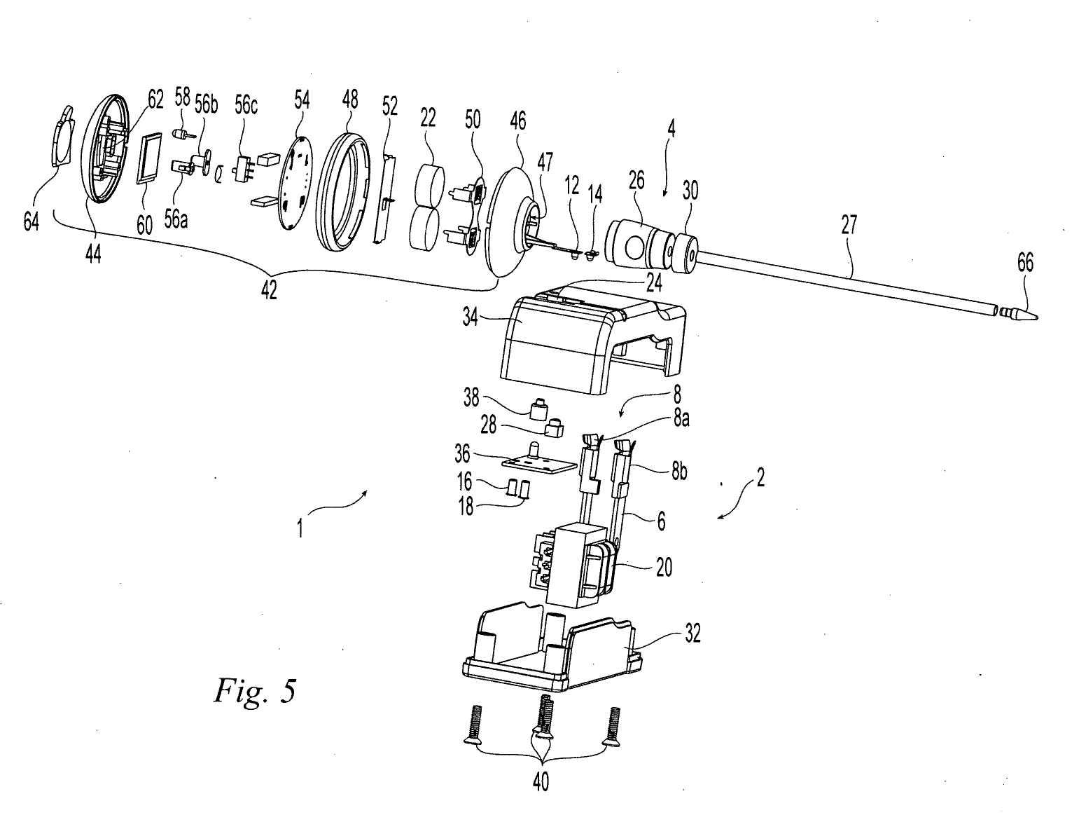

Referring to FIG. 5, an exemplary illustration of the components of the rechargeable food safety thermometer system 1 is shown. Charging portion 2 may comprise first and second casing portions 32, 34 which are connectable to form an interior cavity which may house the electrical adapter/transformer 20, contacts 16, 18, plug 6 and pass-through plug element 8a, 8b. Magnet 28 may also be housed between the casing portions 32, 34 and a portion of the magnet may protrude through an opening in the second casing portion 34 within recess 24. A printed circuit board 36 may be provided with a light-emitting-diode (LED) 38 to indicate when the battery 22 in the thermometer 4 has been fully charged and is thus ready for use. The LED 38 thus may protrude through an opening in the second casing portion 34 adjacent recess 24 so that when lit, the LED is easily visible to the user. In the illustrated embodiment, the first and second casing portions 32, 34 are connected using a plurality of screws 40, although other connection scenarios are also possible (e.g., snap-fit, press-fit, gluing, fusion bonding, etc.)

Thermometer 4 may comprise a housing portion 42, a neck portion 26, and a shaft 27. The housing portion 42 may comprise first and second shells 44, 46, which may be connected to each other by a central ring portion 48. The first and second shells 44, 46 and central ring portion 48 may contain the operating and display electronics of the thermometer 4. The second shell 46 may connect to the neck portion 26. Contacts 12, 14 may extend axially through a central opening 47 in the second shell 46 so that they may be received within appropriate recesses (not shown) within the neck 26 when the neck 26 and second shell 46 are engaged. Contact 12, which may be the positive contact, is electrically connected to the rechargeable battery 22 via a pair of battery connectors 50, 52. In the illustrated embodiment, battery 22 comprises a pair of rechargeable battery cells, although it will be appreciated that any appropriate number of individual battery cells can be used, depending upon the application and energy needs of the device.

A printed circuit board 54 may be disposed between the central ring portion 48 and the first shell 46, and may contain appropriate circuitry for controlling the indicating functions of the thermometer (e.g., food type, doneness criteria, temperature indication, etc.). A switch assembly 56a-c may be provided to enable the user to interact with the thermometer, such as by selecting a type of food whose temperature will be measured or selecting a doneness level for a particular food. The switch assembly 56a-c may also be used to reset the thermometer, and to turn the thermometer on and off, as desired. Thus, a button portion of the switch assembly 56a-c may protrude through the first shell and may be resiliently mounted so that by pressing the assembly, the user can scroll through a list of desired actions. It will be appreciated that although only a single switch assembly is illustrated, a plurality of such assemblies may also be provided to provide a multitude of potential functionalities. Thus, one switch could be used to turn the thermometer on/off; a second switch could be used to select a type of food product to be sensed; a third switch could be used to select a desired doneness level; a fourth switch could be used to reset the thermometer 4, etc.

A display LED 58 may be provided on the printed circuit board 54 for use in signaling at least one operating condition to the user. For example, the display LED 58 may light up when a temperature has been sensed that would indicate the food product being monitored has reached a selected level of doneness. Alternatively, the display LED 58 may light up when the thermometer has reached a full charge level.

A liquid crystal display (LCD) 60 may further be provided directly adjacent to the first shell 44 and may be used to display one or more messages to the user. As such, the first shell 44 may have a transparent section or an opening 62 that substantially aligns with the LCD 60 so that the LCD can be viewed through the first shell 44. A clear lens 64 may further be provided over a portion of the first shell 44 to cover and protect the LCD 60.

Thus arranged, the user can interact with the thermometer 4 via the housing portion 42 to control the operation of the thermometer 4 and to view information relating to the temperature and/or doneness level of the food product being monitored.

At the opposite end of the thermometer 4, a tip 66 may be disposed at the end of the shaft 27 to facilitate advancement of the shaft into the food product whose temperature is to be tested. In one embodiment, the tip 66 may be sharp to allow it to pierce the food product.

Referring to FIG. 3, a face 68 portion of the thermometer 4 is illustrated, showing a pair of switches 56 for selecting an on/off condition and for selecting a type of food product to be sensed (e.g. “CHK,” “PRK,” BEF,” FSH:”). LCD 60 displays the temperature (e.g. 160° F.) being sensed by the thermometer 4, which in the illustrated embodiment is in units of degrees Fahrenheit. An additional selectability for the display would be to toggle between a temperature reading in degrees Fahrenheit and degrees Celsius. In one embodiment, the LCD 60 may be back-lit and may have large numbers (each about 10 mm high by about 5 mm wide) to allow for easy reading from several feet away.

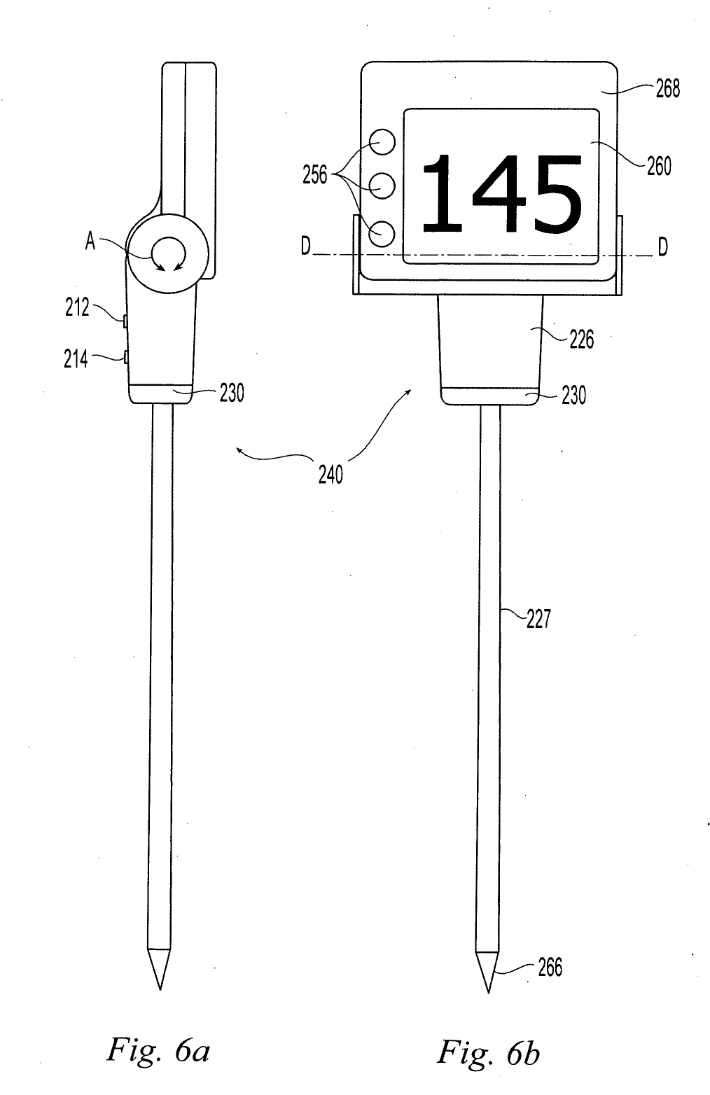

Referring to FIGS. 6a and 6b, an alternative design thermometer 240 is shown having a display face 268, comprising an expanded LCD portion 260 that is substantially larger than the LCD portion 60 of thermometer 4. This expanded LCD portion 260 may cover substantially the entire surface of the display face 268, and may be advantageous because it allows the temperature or other information displayed to be presented in a much larger format. This may allow a user to read the displayed temperature or other information from a greater distance, or in poor lighting conditions, and may also make the device easier to use for persons with poor eyesight. As shown, the thermometer 240 may have a shaft 227, tip 266, neck 226 and metal ring 230 similar to those described in relation to FIGS. 1-5, and configured to cooperate with the corresponding elements of the charging portion 3. Additionally, thermometer 4 may have electrical contacts 212, 214 for engaging corresponding contacts 16, 18 of the charging portion 2.

A backlighting feature may be provided in conjunction with the expanded LCD portion 260 to further enhance the readability of the displayed information. This backlighting may facilitate the use of other features, such as a flashing visual alarm when a desired pre-set temperature is reached, and the like. Such features, while requiring more power for operation than current, smaller, displays, are advantageously implemented in the present invention because the battery 22 of the thermometer 4 undergoes recharging during the period in which the thermometer is not being used (i.e. when it is “docked” with the charging portion 2). Thus, even though the highly desirable enhanced features of the present invention may require more power to operate than current devices, such desirable features may be practically implemented due to the substantially constant recharging capabilities disclosed.

In addition to backlighting, the display face 268 of the thermometer 240 may comprise a color LCD display 260. This color display can be used to provide enhanced visual alarms. For example, the background color of the display face 368 may change depending on the temperature sensed by the thermometer (e.g. blue background for “undercooked,” green for “cooked to within a desired preset temperature range,” red for “overcooked”).

Additionally, the backlighting may change colors to indicate that the unit has reached a stable reading. It may be necessary for the user to wait a few moments as the unit samples the food product and reaches a stable or current temperature. Thus, in one exemplary embodiment, the color display 260 (either the background, the numbering or a separate icon) may initially bear a yellow color, which may then turn to green when a stable temperature is reached, thus providing an easy to understand visual cue that the reading is complete or a stable temperature has been reached.

Additionally, a “touch screen” feature may be implemented into the display face 268, thus allowing the mechanical feature selection buttons 256 to be eliminated from the display face 268. Instead, such “buttons” could be integrated into the “touch screen,” thus resulting in a completely flat-faced design.

Further, the display face 268 may be pivotable with respect to the neck portion 226 to enable the user to read the screen from a variety of positions. For example, the upright position of the display face 268 shown in FIGS. 6a, b may be appropriate when the thermometer 240 is engaged with the charging portion 2. In use, however, the display face 268 may be pivotable about axis D-D in the direction(s) of arrow “A,” thus allowing the display to be inclined with respect to the longitudinal axis of the thermometer shaft 227. This pivoting feature may allow easier reading by a user who is standing directly over the food item being tested.

Referring to FIGS. 7-8c, a second alternative arrangement for the rechargeable thermometer system 100 is shown in which the thermometer 140 is connected to the charging portion 120 in a generally vertical orientation. In this embodiment, the charging portion 120 incorporates a holding sheath 70 which has a bore 72 configured to receive the shaft 27 of the thermometer 140 therein. As with the embodiment of FIGS. 1-5, the charging portion 120 comprises plug 74 and pass-through plug 76 features to allow convenient engagement with a household electrical outlet 78. Additionally, the charging portion 120 and thermometer 140 may have substantially the same internal electronic features, including similar readout and user-interactive features, as previously described in relation to the embodiment of FIGS. 1-5.

As shown in FIG. 8c, the thermometer 140 may have a pair of electrical contacts 78, 80 disposed on an underside surface 82 of the thermometer housing 84. These electrical contacts 78, 80 may be positioned on the housing 84 so as to engage corresponding contacts 86, 88 located on an upward facing surface 90 of the charging portion 120 when the thermometer 140 is engaged with the charging portion 120 as illustrated in FIG. 7. Thus, when the charging portion 120 is plugged into a household electrical outlet 78 and the thermometer 140 is engaged with the charging housing 120, electrical current may be conducted to a rechargeable battery or batteries located within the thermometer 140 for powering the desired thermometer functions.

A detent mechanism 92 is may be provided on the charging portion 120 to ensure that the thermometer 140 is securely engaged by the charging portion 120. This, in turn, ensures that an appropriate electrical contact is maintained between the contacts 78, 80; 84, 86 of the thermometer 140 and charging portion 120 so that an appropriate charge is applied to the rechargeable batteries of the thermometer 140. The illustrated detent mechanism 92 comprises a depending tab element capable of snapping over an upper surface 94 of the thermometer housing 84 when the thermometer shaft 127 is inserted into the bore 72 of the charging portion 120 and the thermometer housing 84 is pressed down into tight contact with the upwardly facing surface 90 of the charging portion. It will be appreciated that the detent mechanism 92 could alternatively be provided as a magnetic detent similar to that described in relation to FIGS. 1-5.

Accordingly, it should be understood that the embodiments disclosed herein are merely illustrative of the principles of the invention. Various other modifications may be made by those skilled in the art which will embody the principles of the invention and fall within the spirit and the scope thereof.

1. A rechargeable food monitoring system, comprising:
a thermometer having a probe portion, a display portion, a neck portion disposed between the probe portion and the display portion; and a rechargeable battery electrically connected to a charge receiving surface, said battery configured to provide operating power to said thermometer;
a charging assembly having a casing comprising a recess for engaging the neck portion of the thermometer, a plug for engaging an electrical outlet, and a charging surface configured to contact said charge receiving surface of said thermometer when said thermometer is engaged with said charging assembly;
wherein the casing further comprises a plug fixed to the casing to support the charging assembly above a work surface when the plug is engaged with the electrical outlet;
wherein the charging surface is electrically connected to the plug to conduct electricity from the electrical outlet to the battery via contact between the charging surface and the charge receiving surface when the thermometer is engaged with the charging assembly.

2. The system of claim 1, the charging assembly further comprising a plug receiving element configured to allow an auxiliary electrical device to be plugged into said charging assembly; wherein the plug receiving element is disposed within the casing.

3. The system of claim 1, further comprising a detent for releasably connecting said thermometer to said charging assembly.

4. The system of claim 3, wherein said detent comprises a magnetic detent.

5-6. (canceled)

7. The system of claim 1, wherein said charging assembly comprises an indicator to signal when said battery of said thermometer is charged by a predetermined amount.

8. (Canceled)

9. The system of claim 1, wherein said display portion comprises an indicator for indicating when said thermometer measures a preselected temperature.

10. The system of claim 9, wherein said preselected temperature is variably selectable by a user.

11. (canceled)

12. A rechargeable temperature monitoring system, comprising:
a rechargeable thermometer having a probe portion with a piercing tip disposed at a distal end of said probe portion, a display portion, a neck portion disposed between the probe portion and the display portion, a rechargeable battery, and an electrical charge receiving surface;
a charging portion being releasably connectable with the neck portion of said rechargeable thermometer, said charging portion comprising a casing and plug assembly for engaging an electrical outlet to receive electrical current therefrom, said charging portion further comprising an electrical charging surface;
wherein the plug is fixed to the casing to support the charging assembly and thermometer above a work surface when the plug is engaged with the electrical outlet; and
wherein when said rechargeable thermometer is received by said charging portion, said electrical charge receiving surface contacts said electrical charging surface to conduct electricity from said electrical outlet to said rechargeable battery.

13. The system of claim 12, the casing further comprising a plug receiving element configured to allow an electrical device to be plugged into said charging assembly to receive electrical current from said electrical outlet when said plug assembly is engaged with said electrical outlet.

14. The system of claim 12, further comprising a detent for releasably connecting said rechargeable thermometer to said charging portion.

15. The system of claim 14, wherein said detent comprises a magnetic detent, the magnetic detent comprising a first magnetic element disposed on the neck of the rechargeable thermometer and configured to releasably connect to a second magnetic element disposed on the charging portion.

16-17. (canceled)

18. The system of claim 12, wherein said charging portion comprises an indicator for signaling when said rechargeable battery is charged by a predetermined amount.

19. The system of claim 12, wherein said rechargeable thermometer further comprises a display portion for displaying a temperature measured by said rechargeable thermometer.

20. The system of claim 19, wherein said display portion comprises an indicator for indicating when said thermometer measures a preselected temperature.

21. The system of claim 20, wherein said preselected temperature is variably selectable by a user.

22. A rechargeable food monitoring system, comprising:
a rechargeable thermometer having a probe portion, a display portion, an electrically conductive surface, and a rechargeable battery electrically connected to said electrically conductive surface; and
a charging assembly comprising a casing with a recess for receiving at least a portion of said rechargeable thermometer, and a plug portion for engaging an electrical outlet to receive electrical current therefrom, said charging assembly further comprising a charging surface disposed within said recess for contacting said electrically conductive surface of said rechargeable thermometer when said rechargeable thermometer is received within said recess to thereby transfer an electrical current from said electrical outlet to said rechargeable battery;
wherein said charging assembly has a first detent element to lock said rechargeable thermometer to said charging assembly, said first detent element disposed adjacent to said charging surface within the recess of the casing.

23. The system of claim 1, wherein the recess in the casing is shaped to conform to a corresponding surface on the neck of the thermometer.

24. The system of claim 1, wherein the recess comprises a first portion that engages the neck portion of the thermometer and a second portion for receiving at least a portion of the probe portion of the thermometer.

25. The system of claim 1, wherein the charge receiving surface is disposed on the neck portion.

26. The system of claim 4, wherein the magnetic detent comprises a first magnetic element disposed on the neck portion of the thermometer.

27. The system of claim 26, wherein the magnetic detent further comprises a second magnetic element disposed within the recess to engage the first magnetic element.

28. The system of claim 12, further comprising a sheath that overlies the probe portion and the piercing tip when the thermometer is engaged with the housing.

29. The system of claim 28, wherein a portion of the sheath is received within a portion of the recess when the thermometer is engaged with the charging assembly.

30. The system of claim 28, wherein the sheath is integral with the housing such that separating the thermometer from the charging assembly separates the probe portion from the sheath.

30. The system of claim 12, wherein the charging assembly comprises a recess for receiving the neck portion of the rechargeable thermometer, the electrical charge receiving surface is disposed on the neck portion, and the electrical charging surface is disposed in the recess of the charging portion.

33. The system of claim 22, wherein said casing further comprises an electrical socket element for receiving a plug of an electrical device, said electrical socket element being integral with said casing and allowing said electrical device to receive electrical current from said electrical outlet.
